(19) United States
(12) Patent Application Publication
(10) Pub. No.: US 2006/0279220 A1
(43) Pub. Date: Dec. 14, 2006

(54) Electric lamp comprising aluminum oxide and cerium oxide

(76) Inventors: Simon Flink, Eindhoven (NL); Simon Krijnen, Eindhoven (NL); Sebatianus Nicolaas Gerardus Cuppen, Eindhoven (NL); Gerbrand Jacob Swart, Winschoten (NL); Willem Wage, Winschoten (NL); Frank Van Der Meulen, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/570,440

(22) PCT Filed: Aug. 20, 2004
(86) PCT No.: PCT/IB04/51515

§ 371 Date: Mar. 2, 2006

(30) Foreign Application Priority Data
Sep. 9, 2003 (EP) 03103332.7

(51) Int. Cl. H01J 19/78

(52) U.S. Cl. 315/58

(57) ABSTRACT

The invention relates to an electric lamp provided with a light source in a light-transmitting lamp vessel which is closed in a vacuumtight manner, which light source has an envelope of light-transmitting, UV-absorbing quartz glass which comprises silicon oxide, aluminum oxide and cerium oxide, characterized in that the quartz glass of the envelope comprises the aluminum oxide and cerium oxide in a molar ratio of between 0.30 and 0.48. The invention further relates to the quartz glass which is used for said lamp.

The invention relates to an electric lamp provided with a light source in a light-transmitting lamp vessel which is closed in a vacuumtight manner, which light source has an envelope of light-transmitting, UV-absorbing quartz glass which comprises silicon oxide, aluminum oxide, and cerium oxide.

An electric discharge lamp of this kind is known from EP 658920. This known lamp has a quartz glass lamp vessel, which has a layer of doped quartz glass at its outer surface. The lamp comprises an envelope of light-transmitting, UV-absorbing quartz glass which contains aluminum in oxide form and a metal in oxide form chosen from a group to which cerium and titanium belong, wherein the quartz glass of the envelope comprises silicon, cerium, titanium, europium, and aluminum in oxide form, cerium accounting for 0.1-0.2 atom %, titanium for 0.01-0.04 atom %, europium for 0.03-0.2 atom %, and aluminum for a maximum of 0.8 atom % of the cationic elements, while the atomic ratio aluminum/europium lies in the region 3 to 8.

Similar lamps were disclosed in U.S. Pat. No. 5,464,462 and U.S. Pat. No. 5,572,091, wherein lamps containing both aluminum and cerium oxides were described, optionally with small quantities of titanium oxide. According to these patents, the molar ratio of the components aluminum oxide and cerium oxide is at least 0.5.

It was found that these prior art lamps have UV-blocking properties that are insufficient for some applications, such as for sleeves in XL-lamps.

It is an object of the invention to provide an electric lamp of the kind mentioned in the opening paragraph which has an envelope which is at least substantially transparent to visible radiation and which has sufficient UV radiation blocking properties to be used in XL-lamps.

According to the invention, this object is achieved in that the quartz glass of the envelope comprises UV-absorbing quartz glass which comprises silicon oxide, aluminum oxide and cerium oxide, wherein the quartz glass of the envelope comprises the aluminum oxide and cerium oxide in a molar ratio of between 0.30 and 0.48.

It was found that quartz glass in which said oxides are present in the given ratios in a silicon oxide (SiO₂) matrix is at least substantially transparent to visible radiation and substantially impervious to UV radiation. The quartz glass, which will also be referred to as doped quartz glass hereinafter, owes these properties to all its components in their stated quantities in conjunction.

In a preferred embodiment according to the invention, the envelope of the electric lamp further comprises titanium oxide in a molar ratio to aluminum oxide of between 1 and 3.

Even better results are obtained when the electric lamp further comprises europium oxide in its envelope, wherein cerium oxide accounts for 0 to 0.5 mole %, titanium oxide for 0 to 0.05 mole %, europium oxide for 0.01 to 0.05 mole %, and aluminum oxide for a maximum of 0.2 mole %, with the molar ratio aluminum oxide/europium oxide lying between 3 and 10.

A preferred advantageous lamp according to the invention comprises 0.33±0.015 mole % of cerium oxide, 0.03±0.01 mole % of titanium oxide, 0.18±0.015 mole % of aluminum oxide, and 0.02±0.006 mole % of europium oxide.

The elements cerium, titanium, and europium each absorb a spectral portion of the UV radiation, which portions supplement one another and partly overlap one another. The aluminum oxide keeps the europium in substantially its bivalent form dissolved in the matrix. Especially at a molar ratio Al₂O₃/Eu₂O₃ of 4 or higher, the UV absorption by europium is high as a result, as is the transmission of light. A favorable influence of aluminum is furthermore that it counteracts the rheological changes of the quartz glass caused by the presence of the bivalent europium. It was found to be favorable if there are at least four, in particular four aluminum atoms available for each europium atom in the doped quartz glass.

The bivalent form will arise during melting in a reducing atmosphere, for example of helium and hydrogen, also if europium is present in the trivalent oxide form in the batch from which the quartz glass is obtained. The batch may comprise the oxides of the cationic elements of the doped quartz glass or alternatively mixed oxides of such elements.

In general, the quartz glass envelope of the light source will have a thickness of at least approximately 1 mm. The minimum quantities of the additives for the glass are based on this. Smaller quantities would render the glass insufficiently impervious to UV radiation. Given the maximum quantities of additives, the doped quartz glass will still comprise approximately 97% by weight of silicon oxide and will still have the properties of molten silicon oxide to a high degree, apart from the optical properties. The doped quartz glass may contain impurities introduced by its components.

The light source may be an incandescent body, for example made of tungsten, for example arranged in an inert gas comprising halogen. Alternatively, the light source may be a pair of electrodes in an ionizable medium, between which electrodes a discharge arc, for example at high pressure, is maintained during operation. The ionizable medium may comprise a rare gas, possibly with mercury, possibly with metal halide.

The lamp vessel and the envelope of doped quartz glass may be integral, in which case the lamp vessel, for example, consists entirely of the doped quartz glass.

Alternatively, the envelope may be a separate body, for example, a body surrounding the lamp vessel. The envelope may then be an outer bulb which is closed in a vacuumtight manner, but alternatively it may be a body between the lamp vessel and an outer bulb, for example a tubular body, which may or may not be closed at one end or both ends.

The envelope is important in all those cases in which the light source generates not only visible radiation but also UV radiation, and the lamp is to be used on account of the visible radiation generated. It is then prevented that the UV radiation causes injury or damage to living beings or goods. The envelope may also be important for bringing the light source to a higher temperature than it would have in the absence of the envelope. This generally benefits the luminous efficacy of the lamp. The envelope in the form of a tube in an outer bulb or of an outer bulb may also contribute to the safety of the lamp if there is a risk of the lamp vessel exploding and fragments thereof causing damage to the surroundings of the lamp in the absence of the envelope.

Embodiments of the electric lamp according to the invention are shown in the Figures.

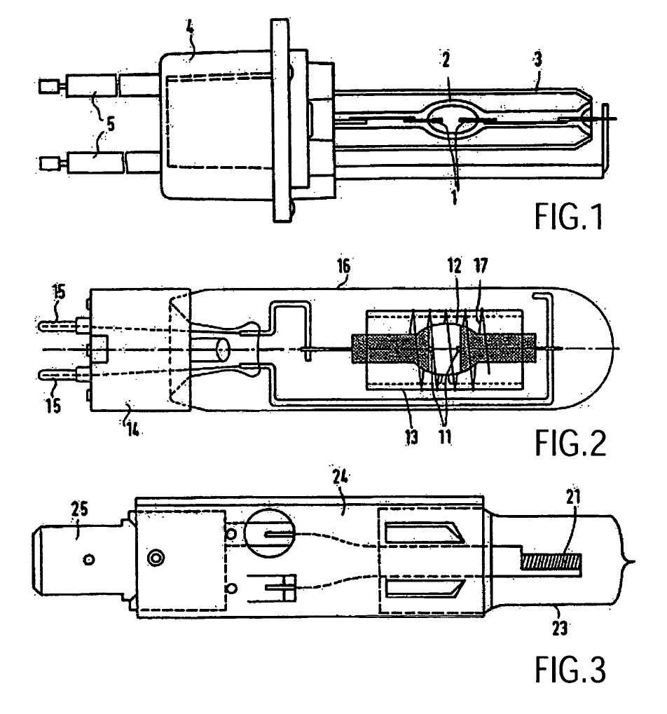

FIG. 1 shows a first embodiment in side elevation;

FIG. 2 shows a second embodiment in side elevation;

FIG. 3 shows a third embodiment in side elevation; and

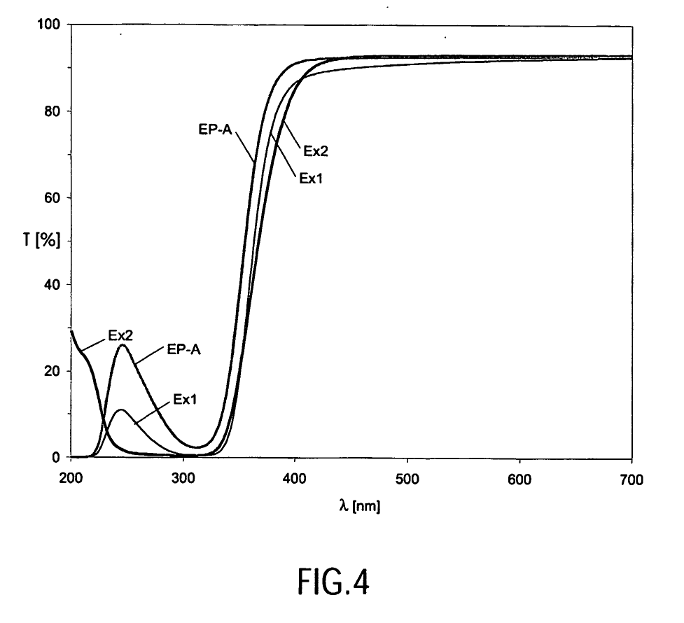

FIG. 4 shows the transmission curve of a glass 1 (Ex 1) and such curve of a prior art glass such as described in U.S. Pat. No. 5,464,462 and U.S. Pat. No. 5,572,091.

In FIG. 1, the electric lamp is provided with a light source 1 in a transparent quartz glass lamp vessel 2 which is closed in a vacuumtight manner. The light source in this Figure is a pair of electrodes in an ionizable gas, for example rare gas, mercury and metal halides. The light source has an envelope 3 of light-transmitting, UV-absorbing quartz glass which comprises aluminum oxide and cerium oxide, and possibly a metal oxide chosen from titanium oxide and europium oxide. The envelope of doped quartz glass is fused to the lamp vessel at the ends of the latter. The lamp has a lamp cap 4 from which cables 5 issue to the exterior for connection to a supply source. The lamp may be used as a motorcar headlamp.

The lamp drawn has an envelope of doped quartz glass obtained from a batch having the composition of glass 1 from Table 1.

In FIG. 2, corresponding parts have reference numerals which are ten higher than those in FIG. 1.

The discharge lamp for general lighting purposes shown here has a tubular envelope of doped quartz glass 13 inside an outer bulb 16 which is closed in a vacuum tight manner. Said envelope is surrounded by a helically coiled metal wire 17 and absorbs the UV radiation generated by the light source while transmitting the visible radiation. Together with the metal wire, the envelope prevents damage to the outer bulb 16 if the lamp vessel should explode. The lamp cap 14 has contact pins 15.

In FIG. 3, corresponding parts have reference numerals which are twenty higher than those in FIG. 1. The lamp has an incandescent body as the light source. The envelope 23 of doped quartz glass is closed in a vacuumtight manner. It has thus been integrated with the lamp vessel. It may be filled with a gas comprising halogen. The metal lamp cap 24 has the shape of a tube, which supports an insulated contact 25 and which itself serves as a second contact. The lamp is suitable for acting as a UV-free motorcar lamp. Examples of the batches giving the doped quartz glass, which may be used in the electric lamp according to the invention have been given in Table 1 in molar percents, glass 1 and glass 2 also in percents by weight.

FIG. 4 shows the transmission curve of the quartz glass obtained from the batch of example 1 (glass 1) from the Table and a similar curve of a prior art glass (such as described in U.S. Pat. No. 5,464,462 and U.S. Pat. No. 5,572,091). The curve shows that the glass is at least substantially transparent to visible radiation and blocks UV radiation better than does the prior art glass.

### EXAMPLE

The compositions of the glass according to the invention and according to the prior art are given in the Table

| | | | glass 1 | |
|---|---|---|---|---|
| | glass according | | according to | |
| | to prior art | | invention | |
| | wt. % | mole % | wt. % | mole % |
| SiOp₂ | 99.365 | 99.65 | 99.195 | 99.61 |
| Al₂O₃ | 0.135 | 0.080 | 0.135 | 0.080 |
| CeO₂ | 0.46 | 0.161 | 0.63 | 0.222 |
| TiO₂ | 0.04 | 0.030 | 0.04 | 0.030 |
| Eu₂O₃ | 0 | 0 | 0 | 0 |
| ratio Al₂O₃/CeO₂ | | 0.5 | | 0.36 |

1. An electric lamp provided with a light source (1) in a light-transmitting lamp vessel (2) which is closed in a vacuumtight manner, which light source has an envelope (3) of light-transmitting, UV-absorbing quartz glass which comprises silicon oxide, aluminum oxide and cerium oxide, characterized in that the quartz glass of the envelope (3) comprises the aluminum oxide and cerium oxide in a molar ratio of between 0.30 and 0.48.

2. The electric lamp of claim 1, wherein the envelope further comprises titanium oxide in a molar ratio to aluminum oxide of between 1 and 3.

3. The electric lamp of claim 1, wherein the envelope further comprises europium oxide, wherein cerium oxide accounts for 0-0.5 mole %, titanium oxide for 0-0.05 mole %, europium oxide for 0.01-0.05 mole %, and aluminum oxide for a maximum of 0.2 mole %, with the molar ratio aluminum oxide/europium oxide lying between 1 and 20.

4. The electric lamp of claim 1, wherein the quartz glass of the envelope (3) comprises 0.33±0.015 mole % of cerium oxide, 0.057±0.002 mole % of titanium oxide, and 0.13±0.015 mole % of aluminum oxide.

5. UV-absorbing quartz glass comprising silicon oxide, aluminum oxide, and cerium oxide, characterized in that the glass comprises the aluminum oxide and cerium oxide in a molar ratio of between 0.30 and 0.48.

6. The quartz glass of claim 5, wherein the aluminum oxide and cerium oxide are present in a molar ratio of between 0.38 and 0.42.
